(19) United States
(12) Patent Application Publication
(10) Pub. No.: US 2007/0097882 A1
(43) Pub. Date: May 3, 2007

(54) Distribution of data in a network

(75) Inventors: Richard Taylor, Stoke Gifford Bristol (GB); Chris Tofts, Stoke Gifford Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/494,183

(22) Filed: Jul. 26, 2006

(30) Foreign Application Priority Data
Oct. 31, 2005 (GB) 0522223.7

(51) Int. Cl. H04L 12/56

(52) U.S. Cl. 370/254; 370/392

(57) ABSTRACT

A method of distributing data across a network from a server computing node to one or more client computing nodes having file-sharing capability across a network, comprises the steps of: generating, from: (a) a topological map of computing nodes and communications links (‘network elements’) of the network; (b) data providing information on intrinsic connective capacity of links and intrinsic computing capacity of nodes; and (c) temporal profile data relating to the usage of links and nodes over time, a current map of useable network elements; and dispatching data from the server node to a client node via a route which is extant on the current useable map.

The present invention relates to the distribution of data within a network, such as, for example, the distribution of a security patch for an operating system or media data file, for example.

In many instances, networks are constructed, at least in part, in a hierarchical fashion, with some computing entities in a network being topologically located closer to a server computing node than others. Moreover, it is a natural consequence of network configurations that, practically speaking, the number of computing nodes increases the further away one moves topologically from a server node. The distribution of data to a large number of computing nodes at the same time is, therefore, frequently apt to result in a bottleneck as data is transmitted to and from the server node.

One way to ameliorate this is to ensure that many of the computing entities on the network are capable of file sharing with other entities. A file sharing computing node which has received data is thus capable of passing this on to another computing entity (usually known as a ‘peer’), which, in theory reduces the load on the server node. This is not, however, necessarily the case. In the event of demand overload, file-sharing software such as BitTorrent required on both the client and server side, is often unable to dispatch even a single full copy of the requested data file to a single other computing entity. Further, precisely because client computing nodes are usually less powerful than server nodes, it's easier for client nodes to become overloaded.

The present invention provides a method of distributing data across a network from a server computing node to one or more client computing nodes across a network, the method comprising the steps of:
generating, from:
   (a) a topological map of computing nodes and communications links (‘network elements’) of the network;
   (b) data providing information on intrinsic connective capacity of links and intrinsic computing capacity of nodes; and
   (c) data relating to the usage of links and nodes over time,
a current map of useable network elements; and
dispatching data from the server node to a client node via a route present on the current useable map.

### BRIEF DESCRIPTION OF DRAWINGS

Embodiments of the invention will now be described, by way of example, and with reference to the accompanying drawings, in which:

FIG. 1 is a schematic, topological representation of a part of a network;

FIGS. 2 and 3 are tables illustrating, schematically, mapping data on computing nodes and communications links in the network;

FIGS. 4A to C illustrate a temporal profiling of usage of an exemplary network element; and

FIG. 5 is a tree of operable computing nodes at a given instant in time.

### DESCRIPTION OF PREFERRED EMBODIMENTS

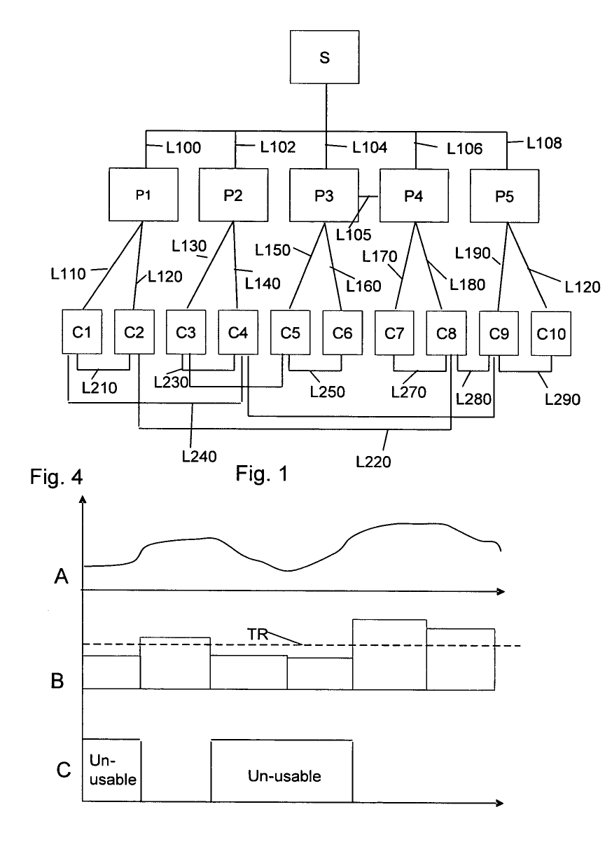

Referring now to FIG. 1, a network includes a node S1 consisting of one or more computing entities which operate primarily in the role of servers (in the sense that their hardware configuration is intended primarily for that purpose). The server node S1 is connected to further computing entities P1 . . . via one or more communications links L100 and the computing entities P are connected via further communications links L200 to yet further computing entities C1 . . . Cn. Further, various amongst the entities P and C are interconnected with each other. The topographically illustrated network is, in the present example, an intranet of a large commercial organisation, which typically has many thousands of computing nodes P and C. However, the present embodiment, and the invention generally, may equally be realised in an entirely different context where the computing nodes are owned and operated by or on behalf of many different legal persons, such as in the context of the Internet, for example. The communications link L100, which for the present purposes can be thought of as an aggregate of all the physical infrastructure which transmits data between the server node and other computing entities which are, topologically speaking, directly connected to it, has an aggregate connective capacity of N bits per second. NB it should be appreciated that, in the present embodiment, the network is illustrated as a plurality of computing nodes and links; computing nodes being any entity that has some ability to perform long-term storage as well as compute; this may or may not, therefore, include infrastructure elements such as routers and switches as the case demands. Thus, computing entities in the present example are those that can run programs which operate above the IP level in the hierarchy of network protocols. The aggregate connective capacity of all the other links in the network is R bits per second and R>N. One embodiment of the present invention relates to a manner of ameliorating a situation in which the total data volume requested by the nodes P and C exceeds N by using the greater connective capacity R to transmit the requested data volume to be transmitted across the network more efficiently and conveniently than would be the case by attempting to use the links N to meet this demand. In addition, embodiments of the invention also take account of actual usage patterns which may reduce the intrinsic computing or connective capacity of the network.

To enable optimum usage of the network capacity, the server preferably possesses: a mapping of the network topology: data on the inherent connective capacity of each of the links; and data on the computational capacity of each of the entities P and C. Such a mapping is relatively easy to obtain by a variety of methods, such as the use of various network utilities such as TraceRoute and Ping for example in relation to topology, as well as various other known tools for establishing connective and computing capacity. This ‘intrinsic map’ can also be updated as new information becomes available, e.g. as a result of observing events such as the allocation of an IP address. Clearly more information on the nature of the network can be obtained in the case of an intranet than would typically be the case for an internet scenario, but in either case sufficient data can usually be legitimately obtained. Further, each computing entity is equipped with a file-sharing application. Typically this will take the form of an application which interacts with and supplements the functionality of a web browser, known as a ‘helper’ application. One example of such an application is BitTorrent. Since such a helper application is required in order to transmit data from one computing node to another by file-sharing, it follows that the a computing node's ability to perform the necessary processing operations has an effect upon the ability of the network to transmit data in this manner. It is for this reason that data relating to computing capability of nodes is gathered and taken into consideration.

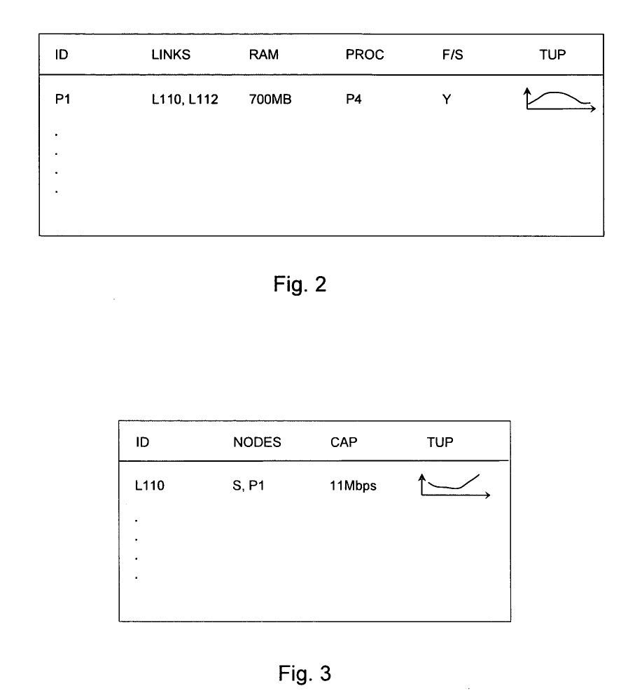

A schematic representation of the data held in respect of each computing entity is illustrated in FIG. 2, where, for the computing entity P1, the data held in respect of each computing entity's ID includes the communications links to which it is connected directly, here links L110 and L120; its memory—700 MB; it's processing capability, here 1.5 GHz (although not shown here, storage capacity may also be important and thus recorded); whether it has file sharing capability; and a temporal usage profile of the CPU. A schematic illustration of the data held in respect of each link is shown in FIG. 3, which provides the link ID, here L110, its inherent connective capacity, 11 Mbps, and a stored temporal usage profile which is normalised to the inherent connective capacity; the combination of the temporal usage profile and the inherent capacity will therefore enable a prediction of the actual connective capacity that the link L110 can offer at any given instant in time.

Installation of the relevant utilities in order readily to obtain the requisite mapping information and helper applications in order to ensure that file-sharing capacity is present on each computing entity is relatively easy to impose upon users in an Intranet scenario, since the computing entities of employees working for an organisation can be subjected to forced installation. By contrast, in an Internet scenario, users will typically agree to join a community in which this information is shared openly in return for certain benefits, which will become apparent subsequently.

In addition to data on the intrinsic capacity of the various network elements, the server also stores what might be thought of as a ‘temporal’ profile of typical usage of computing and connective capacity against time of day for each of the links and each of the computing entities, or if not each of them, then a significant proportion. This provides information on the degree of usage of the inherent capacity. Thus, a given link between two computing entities may be intrinsically capable of transmitting 11 Mbps, but at a particular time of day, the rate of data transmission along that link may typically be 7 Mbps, meaning that the link is only residually capable of providing a capacity of 4 Mbps. Typically this kind of information can be obtained most easily from users by the installation of an appropriate utility on the computing entities which returns the relevant data to the server. An example of such a temporal profile for a particular network element—i.e. a link or a computing node is illustrated in FIGS. 4A-C. The profile is generated from a graph (FIG. 4A) of usage against time, and is then divided into time segments, over which an average is taken (FIG. 4B). These segments are then compared against a threshold value TR, to determine wither the element in question can be deemed operational or not (FIG. 4C).

One purpose of obtaining the mapping data and temporal usage profile is to enable the server node to distribute data efficiently. On occasions when the connective capacity of the link L100 is not being approached or exceeded by the aggregate level of data transmission which is requested of the server by the computing entities P and C, efficiency is of less importance. However, in a number of scenarios where heavy demand is placed upon the server, efficient usage of the network capacity can be more significant. Examples include the case of streaming of media files to all computing entities (e.g. where a Chief Executive wishes to address employees directly by streaming media); distribution of large files to a limited number of computing entities where the file size is significant; or the distribution of smaller data files to all computing entities—e.g. in the case of a security patch, for example. Thus, in any scenario where connective capacity is likely to be approached, efficient network usage becomes an issue.

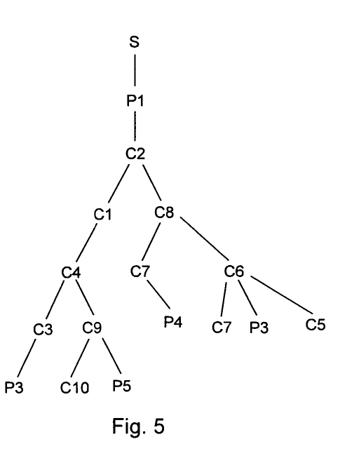

In order to enable efficient usage of the network capacity at any given instant, the server node generates what can be thought of as a substantially real-time useable network map, having the form of a connective tree by applying the temporal usage profile for each element of the network (i.e. link and computing entity) to the intrinsic mapping information. The map is ‘real-time’ in the sense that it represents the current usable topology to within a defined temporal resolution. Referring now to FIG. 5, a conceptually illustrative example of the result of the process of applying the temporal profile is shown for a subset of the computing entities illustrated in FIG. 1. Thus, if, from a temporal profile it is established that for a particular time of day, the link 110 between entity P1 and entity C1 is typically under such heavy usage as to render it of very little use then the tree does not include a link between P1 and C1 (since, due to the heavy usage of that link, constructively, at that instant in time, it is not available for further use) and only shows the P1 as being directly connected to C2 via the link 120. However, there is a further link, 210, between C1 and C2 which, according to the temporal profile, is unused at this time. Accordingly, the tree illustrates C1 as being connected to P1 via C2. Similarly, if the links 106 and 108 which connect the entities P4 and P5 to the server node, and the link 105 which connects entities P3 and P4 are fully or largely utilised at the time in question, the tree does not show those links; instead showing entity P4 is being connected to the server node via L106, P1, L120, C2, L220, C8 and L180. Other elements of the tree in FIG. 5 will not be described in detail since doing so would add nothing to an understanding of its function, but are illustrated because they will enhance an illustrative example subsequently to be described. It should be noted, however, that the tree is degenerate in that some computing nodes are represented more than once as a result of the various connections to them which may be utilised.

It should be appreciated that different trees may be created from the same intrinsic network topology and the same temporal usage profile at the same time of day as a result of differing selection of the threshold value TR (in FIG. 4B) which may be selected on the basis, for example, of required data rate. Thus, if the threshold is set at a high level because large data volumes are required to be transmitted, the temporal usage profile may indicate that a given link is effectively un-operational at a particular time of day, whereas for low data volumes (and thus a low threshold value TR) the relevant elements are still operational. It is, therefore, conceptually possible that the server node may, for example, hold one tree which is applicable for a given time of day for data rates of above, say 4 Mbps, and another for data rates of, for example, below 1 Mbps which may look very different for that reason. In practice, however, the use of the techniques illustrated in the present embodiment produce the greatest benefit in relation to large data volumes. Similarly, other, different factors than temporal variation in usage may be taken into account in establishing a useable tree of network elements, such as, for example potential aggregation of file segments sent along different routes, for example, where a different useable tree may be constructed at local level.

The utility of this approach can be readily appreciated by consideration of a simple example. Having generated the tree illustrated in FIG. 5, the server node then receives requests from all of the computing entities in the network for the provision of a large data file. Topologically, the fastest route to each of the requesting entities P is directly via the links L10x and the fastest route to each of the C requesting entities is via the adjacent P entities. However, once the usage profile for the time of day at which the file request is made is taken into account to generate the tree shown in FIG. 5, it becomes apparent that attempting to transmit copies of the large data file via the topologically fastest route may either fail entirely, or take longer than need be the case.

Thus, for example, instead of attempting to return copies of the data file to the entities P2-P5 directly, and to the adjacent C entities via entities P2-P5, the server node instead dispatches a copy of the data file initially to entities C1 and C8. Because in the present embodiment, all entities in the network are provided with a file-sharing helper application, the data file is dispatched to C1 and C8 via entities P1 and C2 in turn, each of which, in the course of transmitting the data file, thus creates and stores a copy of it for its own use. In sending the data file to entities C1 and C8, it has, in each case, been transmitted across only three network links: L100-L120-L210 in the case of C1, and L100-L120-L220 in the case of C8; in each case this involves transmission across only one further link than would be required via the topologically fastest route. Transmission of the data file to other entities can then be achieved in a number of ways.

One way is to instruct the entities C1 and C8 to transmit the file onwards to the other entities who are below them in the tree, which again only requires, at most, transmission across two further network links. This is possible as a result of the use of the presence of file-sharing software on each entity in an Intranet scenario (in an Internet scenario, the capability of the computing nodes with regard to file sharing will be taken into account in constructing the tree). Alternatively, the server node can merely transmit a pointer via a different route to the remaining entities who require the data file, directing them to the nearest entity which possesses a copy: C1 in the case of C4, C3 and P2; C8 in the case of C7, P4, C10, C9, P5, C6, P3 and C5. The pointer, being very small in size may, depending upon the circumstances, be easily transmitted directly via the topologically fastest route to the relevant requesting entities (NB this may apply in a case were either the current usage map may, due to the small amount of data involved, or that, once the higher level nodes (i.e. those topologically closest to the server have been bypassed, a different usage map may be created, due to the absence of any need to pass data along the higher level links, so that the usage map at a more local level represents more closely the intrinsic topology). This then further reduces the load on the server node as the remaining requesting entities direct their request to the nearest ‘peer’ entity in possession of the data file, as determined by the tree structure. In a further modification, a combination of the two approaches can be advantageously employed. Thus, for example, a copy of the data file can be distributed to node C6 and a pointer to C6 then sent to P3, C5 and C7 to distribute the load across different nodes (in the latter two cases using the degenerate connections to C7 and C5 to advantage to enable load distribution).

It should be noted that, preferably, the data file is transmitted to a location within the network such that any bottleneck is simply not relocated to another point. Thus, for example, this would have been the case had the data file simply have been sent to C2 and then the remaining computing nodes had addressed their request for the file to C2. In contrast, the file was distributed to nodes C1 and C8, with the result that the initial load on each of these nodes is comparable, and the subsequent benefit that the load can be further distributed by use of sub-trees with roots—node C4 in the case of C2 (having further sub-trees with roots C3 and C9) and nodes C6 and C7 in the case of C8; the load is thus, as a result of file-sharing, distributed relatively evenly with increasing topological distance from the P nodes.

In a modification, often applicable in the case of media data files, the file is dispatched in segments X1, X2 . . . Xn. Depending on the nature of the tree which is available to transmit data along, different segments of the file to different parts of the network, and then instructing entities to obtain the remaining parts of the file from a neighbouring entity, the total traffic can be reduced and the file can be again to FIG. 1 in the theoretical instance where the tree mirrors the topology of the network, one half of a data file could be sent to C1, C3, C5, C7 and C9, and the other half to C2, C4, C6 and C8, whereupon adjacently positioned entities which are directly connected, such as C1 and C2 may then simply exchange the missing parts of the data file with each other.

The server node preferably updates the tree upon the occurrence of one or more specified events. Thus, for example, in the event of the failure of a particular data file successfully to navigate a particular route—an occurrence which may, for example, be caused by corruption or un-installation (whether inadvertent or deliberate) of file sharing software, for example—the tree is preferably updated to reflect the change in useable network topology at that time. Preferably a corresponding change is made to the temporal usage profile in order that subsequent tree generation results in as accurate a real-time representation of the useable network as possible.

1. A method of distributing data across a network from a server computing node to one or more client computing nodes having file-sharing capability across a network, the method comprising the steps of:
generating, from:
(a) a topological map of computing nodes and communications links (‘network elements’) of the network;
(b) data providing information on intrinsic connective capacity of links and intrinsic computing capacity of nodes; and
(c) temporal profile data relating to the usage of links and nodes over time,
a current map of useable network elements; and
dispatching data from the server node to a client node via a route which is extant on the current useable map.

2. A method according to claim 1 further comprising the step of dispatching to at least one computing node, a pointer to another node to which data has been dispatched.

3. A method according to claim 2 wherein the data comprises a file having a plurality of segments, and different segments of the file are dispatched to different computing nodes.

4. A method according to claim 3 wherein a first file segment is dispatched to a first computing node, together with a pointer to a second computing node having a second file segment.

5. A method according to claim 1 further comprising the step, upon failure of a data file to reach its intended destination due to failure of a specified network element to function, of generating a further current map of useable network elements which reflects the non-functionality of the specified element.

6. A method according to claim 5 further comprising the step of updating the temporal profile to reflect the inoperability of the specified element.

7. A method according to claim 1 wherein the temporal profile is determined on the basis of a threshold value of capability corresponding to a specified volume of data.

8. A method according to claim 1 wherein communications links between the server node and adjacent computing elements provide an aggregate connective capacity of N bits per second and communications links between all other elements in the network provide an aggregate connective capacity of R bits per second, wherein R>N, and the requested data volume in a given period of time is greater than N but less than R.

9. A computing node in a network of computing nodes and communication links between nodes, the node being adapted to:
store a topological map of computing nodes and communications links (‘network elements’) of the network;
store data providing information on intrinsic connective capacity of links and intrinsic computing capacity of nodes; and
store, for a plurality of elements, a temporal profile data relating to the usage of links and nodes over time;
generate, by applying one or more temporal profiles to the topological map, a current map of useable network elements; and
dispatch data to computing nodes in the network via a route extant on the current map.

10. A computer program product adapted to:
store a topological map of computing nodes and communications links (‘network elements’) of the network;
store data providing information on intrinsic connective capacity of links and intrinsic computing capacity of nodes; and
store, for a plurality of elements, a temporal profile data relating to the usage of links and nodes over time;
generate, by applying one or more temporal profiles to the topological map, a current map of useable network elements; and
dispatch data to computing nodes in the network via a route extant on the current map.
